(19) United States
(12) Patent Application Publication
(10) Pub. No.: US 2026/0047524 A1
(43) Pub. Date: Feb. 19, 2026

(54) COVER CROP SEED APPLICATOR FOR AGRICULTURAL HARVESTING HEADER

(71) Applicant: AGCO Corporation, Duluth, GA (US)

(72) Inventor: Todd Brandon Snyder, Jackson, MN (US)

(21) Appl. No.: 19/297,987

(22) Filed: Aug. 12, 2025

Related U.S. Application Data
(60) Provisional application No. 63/683,909, filed on Aug. 16, 2024.

(51) Int. Cl. A01D 43/14; A01C 7/08; A01D 45/02

(52) U.S. Cl. CPC A01D 43/14; A01C 7/08; A01D 45/021

(57) ABSTRACT

An agricultural machine configured to harvest a crop by advancing a crop harvesting header across a field, the agricultural machine presenting a fore-and-aft extending longitudinal axis that extends in a travel direction, the harvesting header having a header frame that mounts a cutting platform configured to sever crop being harvested, the header frame having a header axis that extends perpendicular to the direction of travel, wherein the agricultural machine has a cover crop seed dispensing apparatus with a seed dispenser and a distribution line mounted along the header frame, the distribution line having a plurality of distribution points at spaced intervals along the header axis. The seed dispenser meters seed delivery to the distribution line so as to distribute cover crop seed from the plurality of distribution points as the harvesting header severs crop from the field.

### CROSS-REFERENCE TO RELATED APPLICATION

This application claims the benefit of the filing date of U.S. Provisional Patent Application 63/683,909, “Particulate Additive Dispensing Apparatus,” filed Aug. 16, 2024, the entire disclosure of which is incorporated herein by reference.

### BACKGROUND

### Field

This disclosure relates to cover crop seed dispensing systems, and in particular to a cover crop seed dispensing system mounted on a harvesting header for metering the rate of cover crop seed dispensed by the agricultural machine.

### Description of Related Art

The use of cover crops has long been recognized as beneficial to soil health. In particular, it is commonly recognized that cover crops help manage soil erosion, soil fertility, soil quality, water, weeds, and pests. Use of cover crops help optimize soil health through nutrients and organic matter provided by continuous live root systems, provide the ability to plant nitrogen scavenging or producing crops, aid in capturing unused nutrients in the soil to be used in future crops utilization, and to help reduce greenhouse gasses. In so doing, cover crops often help provide higher yields for cash crops. To take advantage of these benefits, cover crop seeds are generally dispensed either shortly before or after harvesting a cash crop in agricultural settings. While cover crop seeds can be dispensed in many ways, cover crop seed has typically been dispensed using a broadcast spreader pulled behind a tractor after harvesting is complete.

One problem with cover crops, especially in the northern part of the United States and Canada, is the timing of the seed germination and growth before the winter months. If the farmer does not have time to plant the cover crop after the cash crop has been harvested, a cover crop is not planted as there is no effective way to get the seeds established.

During harvesting, harvesting machines, such as combine harvesters (often referred to as just “combines”), are generally utilized. In use, a harvesting header mounted on the combine severs the crop to be harvested and moves it into the combine to be processed so the valuable portions can be collected, and the residue can be disposed of.

It would be beneficial if there was a cover crop seed dispensing system which could be used as the harvesting machine is already in the field at the time of harvest. Additionally, it would be beneficial to have a cover crop seed dispensing system for use with a harvesting header that is capable of accurately metering seed when used with different types of cover crop seed and with different harvesting header setups.

### BRIEF SUMMARY

In one aspect, the invention is directed to an agricultural machine configured to harvest a crop by advancing a crop harvesting header across a field. The agricultural machine presents a fore-and-aft extending longitudinal axis that extends in a travel direction, the harvesting header having a header frame that mounts a cutting platform configured to sever crop being harvested, the header frame having a header axis that extends perpendicular to the direction of travel. The agricultural machine has a cover crop seed dispensing apparatus with seed dispenser and a distribution line mounted along the header frame, the distribution line having a plurality of distribution points at spaced intervals along the header axis. The seed dispenser meters seed delivery to the distribution line so as to distribute cover crop seed from the plurality of distribution points as the harvesting header severs crop from the field.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an agricultural machine with a cover crop seed dispensing apparatus in accordance with one embodiment;

FIG. 2 shows one embodiment of the cover crop seed dispensing apparatus of FIG. 1;

FIG. 3 shows an isometric view from beneath of the flow control element shown in FIG. 6;

FIG. 4 shows a side view of elements of the cover crop seed dispensing apparatus of FIG. 2 with several panels removed;

FIG. 5 shows an isometric view from above of a first example flow control element for use with the cover crop seed dispensing apparatus;

FIG. 6 shows a sectional view of a cover crop seed chain belt dispenser used in the cover crop seed dispensing apparatus of FIG. 4;

FIG. 7 shows an isometric view of the flow control element for use with the cover crop seed dispensing apparatus;

FIG. 8 shows an isometric end view of the flow control element shown in FIG. 6;

FIG. 9A shows a plan view of a second example flow control element;

FIG. 9B shows an isometric view from above of the flow control element of FIG. 9A;

FIG. 10A shows a plan view of a third example flow control element; and

FIG. 10B shows an isometric view from above of the flow control element of FIG. 10A.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already be widely known or used by persons skilled in the art and each will likewise not therefore be discussed in significant detail.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present invention can include a variety of combinations and/or integrations of the embodiments described herein.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

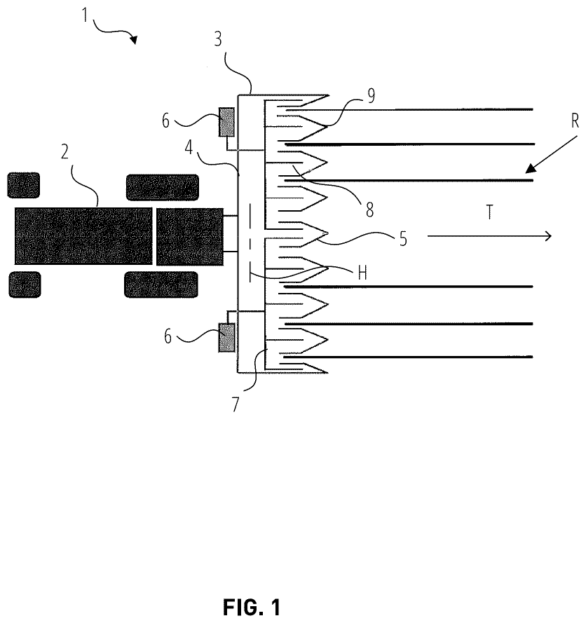

Turning initially to FIG. 1, an agricultural machine 1 is operable to be advanced in a forward direction to harvest crop from a field. The agricultural machine 1 presents a fore-and-aft extending longitudinal axis T that extends in the direction of travel. In one embodiment, the agricultural machine 1 is preferably configured to harvest a crop and broadly includes a combine harvester 2 with a crop harvesting header 3. The harvesting header 3 has a header frame 4 that mounts a cutting platform 5 configured to sever the crop to be harvested as the agricultural machine 1 travels through the field. As is known in the art, the combine harvester 2 comprises a self-propelled machine that collects the separated grain and generally discharges material other than grain (MOG) onto the field. The embodiment of harvesting header 3 illustrated is a corn header that is operable to harvest a corn crop by advancing along a series of side-by-side corn rows R to sever and gather corn plants from the field. However, it is within the ambit of the present invention that the harvesting header 3 is alternatively configured and used to harvest other crops, such as sorghum, soybeans, sunflowers, etc. The header frame 4 has a header axis H that extends perpendicular axis T and direction of travel, with the cutting platform 5 having a plurality of row units spaced laterally along the header axis H on the header frame 4.

The agricultural machine 1 also has a cover crop seed dispensing apparatus 6 mounted thereon to distribute cover crop seed as the agricultural machine 1 harvests the crop. In one embodiment, the cover crop seed dispensing apparatus 6 is mounted on the frame 4 of the harvesting header 3 and includes a distribution line 7 directing cover crop seed to a plurality of distribution points 8 spaced along the major axis of the header frame 4. Desirably, the distribution points 8 are positioned along the header frame 4 such that the distribution points 8 align with the space between the rows R of crop being harvested so as to lay down a cover crop between the side-by-side rows R being harvested. In the illustrated embodiment, the harvesting header 3 has a first cover crop seed dispensing apparatus 6 on a left side of the harvesting header 3 to supply the distribution points 8 on the left side and a second cover crop seed dispensing apparatus 6 on a right side of the harvesting header 3 to supply the distribution points 8 on the right side.

Cover crop seed is loaded into and metered out by the cover crop seed dispensing apparatus 6 as will be described below and delivered into an air stream in the distribution line 7 so that the cover crop seed is dispersed by the distribution points 8 directly to the ground. Mechanisms for providing an airstream in a distribution line are known in the art and need not be discussed in detail herein. In one embodiment, the harvesting header 3 has a plurality of corn head snoots 9 and the distribution points 8 deliver the cover crop seed under the corn head snoots 9 directly to the field. The fodder and debris left by the combine harvester 2 then covers the cover crop seeds dispersed on the field to promote growth. While the illustrated embodiment has been described with a harvesting header 3 for harvesting corn, one skilled in the art will understand that the distribution line 7 with distribution points 8 on the harvesting header 3 will also work with a straight cut or sickle harvesting headers 3 configured for other crops such as soybeans.

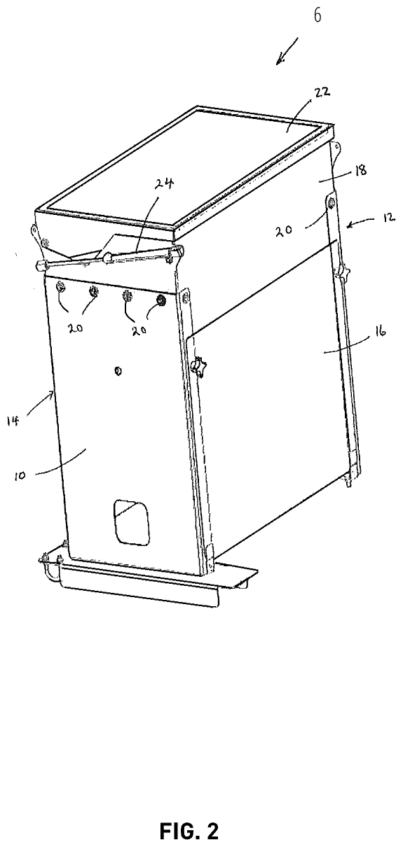

Referring now to FIG. 2, an example cover crop seed dispensing apparatus 6 configured to meter a desired rate of cover crop seed is shown that may be installed on the frame 4 of the harvesting header 3 of the agricultural machine 1. The cover crop seed dispensing apparatus 6 comprises a generally box like structure comprises left- and right-hand side walls 10, 12 connected by front and rear walls 14, 16. The cover crop seed dispensing apparatus 6 is conveniently provided with structures allowing the cover crop seed dispensing apparatus 6 to be secured to the harvesting header 3, for example a bracket to be connected to frame 4. Desirably, the rear wall 16 may be releasably secured to the side walls 10, 12.

A hopper or chute 18 is located at an upper end of the box like structure, the hopper or chute 18 being secured in any suitable manner to the boxlike structure, for example by fastenings 20 provided at an upper region of the side walls 10, 12. The hopper or chute 18 comprises front, rear and left and right hand generally vertical upper side walls connected to corresponding front, rear and left and right generally vertical lower side walls by inclined front, rear and left and right wall portions.

The hopper or chute 18 has a lid 22 hingedly attached to an upper edge the rear upper side wall. Conveniently, a gas strut 24 is provided to one side of the hopper or chute 18 to assist in keeping the lid 10 in either an opened or closed position.

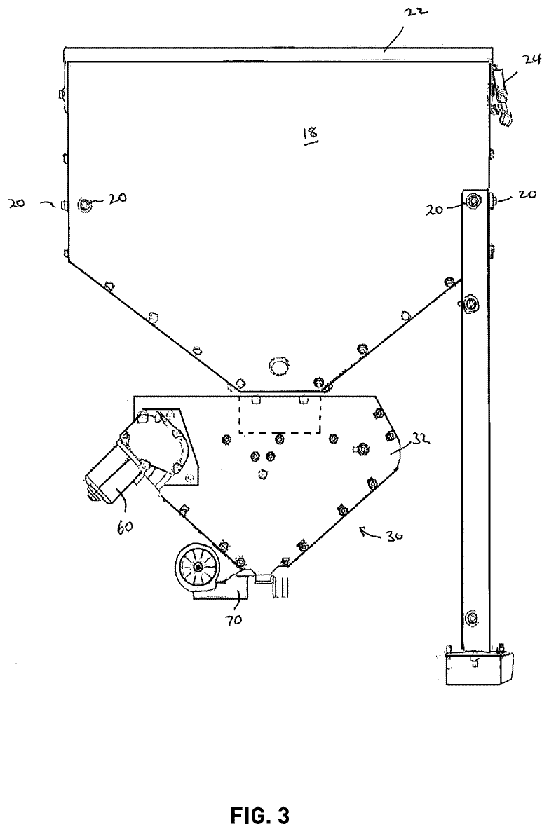

The front and rear generally vertical lower side walls of the hopper or chute 18 support a seed dispenser 30 housed within the box like structure of the additive dispensing apparatus 2. As best seen in FIG. 3, the lower ends of the hopper or chute 18 are arranged to fit within an entry formed at an upper part of the seed dispenser 30.

The seed dispenser 30 comprises first and second side walls 32, 34. The first and second side walls 32, 34 are held at a fixed distance by a plurality of suitably located pins 36 or other suitable fasteners.

Conveniently, the front and rear generally vertical lower side walls of the hopper or chute 18 are secured to a respective first or second side walls 32, 34 of the seed dispenser 30 by suitable fasteners.

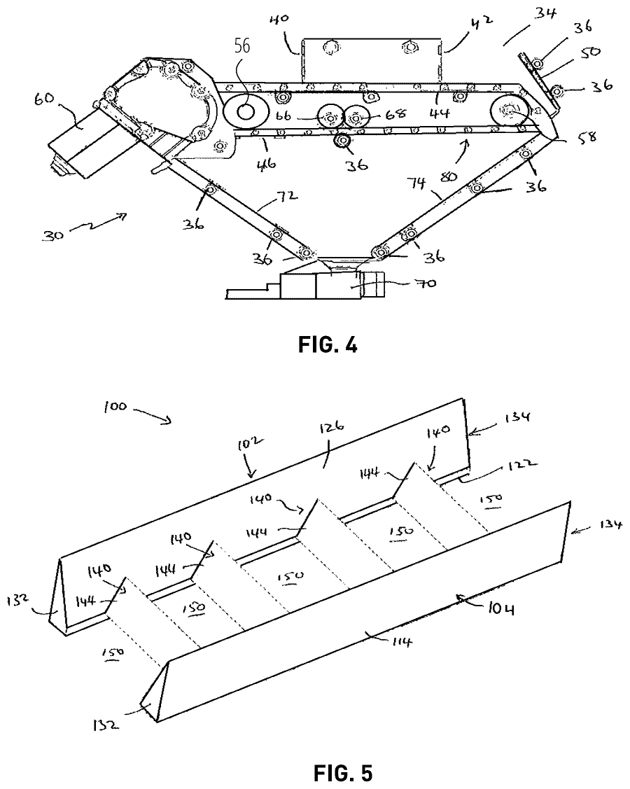

As seen in FIG. 4, between the first and second side walls 32, 34 there are provided first and second guide plates 40,42 arranged at an upper region of the seed dispenser 30. In the illustrated embodiment, the guide plates 40, 42 are arranged parallel to one another to create a vertical opening. Alternatively, the guide plates 40, 42 may be inclined with respect to the vertical and with respect to one another. The guide plates 40, 42 together with the first and second side walls 32, 34 define the entry to the seed dispenser 30.

First and second support plates 44, 46 are provided extending horizontally between the first and second side walls 32, 34. The first support plate 44 extends beneath the first and second guide plates 40,42, first and second free ends of the first support plate 44 extending to either side of the lower ends of the first and second guide plates 40,42. The second support plate 46 is located at a level beneath the first support plate 44 and horizontally offset from the first support plate 44. In the illustrated embodiment, each end of each of the first and second support plates 40,42 is provided with a downwardly inclined flange or lip.

Each of the guide plates 40, 42 and the support plates 44, 46 are conveniently supported from one of the first and second side walls 32, 34 by way of connecting brackets. Alternatively, as illustrated, each of the guide plates 40, 42 and the support plates 44, 46 may be provided with lands and valleys, such that the lands form teeth to be fitted within corresponding openings in the side walls 32, 34.

To each end of the seed dispenser 30 are provided first and second rollers 56, 58 supported on axes extending between the first and second side walls 32,34 of the seed dispenser 30. The first and second rollers 56, 58 are of corresponding diameters. The first roller 56 is additionally provided with a drive mechanism 60 mounted to the first side wall 32 externally of the seed dispenser 30.

Conveniently, first and second further rollers 66, 68 may be mounted for free rotation on axes extending between the first and second side walls 32, 34 of the seed dispenser 30. In the illustrated embodiment, the first and second further rollers 66, 68 are mounted in a central region of the seed dispenser 30 between the first and second rollers 56, 58 above a lower part of an endless conveyor 80.

Third and fourth guide plates 72, 74 are provided extending between the first and second side walls 32, 34. Each of the third and fourth guide plates 72, 74 has an upper end and a lower end, the upper ends of the third and fourth guide plates being separated from one another a greater distance than the lower ends of the third and fourth guide plates, such that the third and fourth guide plates 72, 74 slope toward one another. Together, the third and fourth guide plates 72, 74 and the first and second side walls 32, 34 define an exit for the cover crop seed from the seed dispenser 30. In the illustrated embodiment, the upper ends of the third and fourth guide plates 72, 74 can be seen to extend beyond first and second ends of the endless conveyor 80.

A Venturi funnel 70 is secured to the exit from the seed dispenser 30. A lower portion of the funnel 70 is connected to a tubular fitting forming part of a pneumatic system for the transport of the cover crop seeds. The further rollers 66, 68 are located above the Venturi funnel 70.

The endless conveyor 80 extends around the first and second rollers 56, 58 such that the first and second rollers 56, 58 define first and second ends of the endless conveyor 80. The endless conveyor 80 comprises a plurality of links 82. In use, open ended cavities 92 are defined between adjacent links 82 in which the cover crop seed may be located when transported.

The first and second rollers 56, 58 may be provided with shaped circumferential surfaces for better engagement with the open-ended cavities defined between the links of the endless conveyor 80.

As may best be seen from FIG. 4, an upper portion of the endless conveyor 80 rides over the first support plate 44 and beneath lower ends of the first and second guide plates 40, 42. A lower portion of the endless conveyor 80 rides over the second support plate 46.

In use, cover crop seed is loaded into the hopper or chute 18 of the cover crop seed dispensing apparatus 6. The cover crop seed will flow down the hopper or chute 18 into the entry of the seed dispenser 30 bounded front and rear by the first and second side walls 32, 34, at its sides between the first and second guide plates 40, 42 and at its base by the endless conveyor 80 and the first support plate 44 between the lower ends of the first and second guide plates 40, 42 where the cavities 92 of the endless conveyor 80 are filled with the cover crop seed.

When it is desired to measure a desired quantity of the cover crop seed from the hopper or chute 18 to a crop, the drive mechanism 60 for the roller 56 is actuated to draw the upper portion of the endless conveyor 80 past the first guide plate 40. Movement of the endless conveyor 80 along the first support plate 44 agitates the cover crop seed and assists in filling of the cavities 92 above the first support plate 44. As the endless conveyor 80 passes beneath a lower end of the guide plate 40, the lower end of the guide plate 40 levels off the cover crop seed located above the upper surface of the links 82.

Cover crop seed within each cavity 92 will be drawn by the endless conveyor 80 along the first support plate 44 until the cover crop seed is free to drop down onto the lower portion of the endless conveyor 80 above the second support plate 46.

Cover crop seed located on and in the links 82 passing over the second support plate 46 is then drawn by the endless conveyor 80 along the second support plate 46 toward the first and second further rollers 66, 68. As the endless conveyor moves over a second end of the second support plate, the cover crop seed is free to drop down from the cavities 94 into the Venturi funnel 70.

The first and second further rollers 66, 68 located above the mouth of the Venturi funnel 70 will displace the links 82 of the endless conveyor 80 around a lower region of the first and second further rollers 66, 68 causing any cover crop seed resting on an upper surface of a link 82 to be displaced through the cavities 92 and downward into the mouth of the Venturi funnel 70.

The pressure differential caused by the air flow at the base of the Venturi funnel 70 will cause an air flow at the mouth of the Venturi funnel 70 also assisting in drawing the cover crop seed into the Venturi funnel 70 from where the cover crop seed will be delivered to the field.

It will also be understood that as the size of the cavities 924 in the endless conveyor 80 is known and the speed of the endless conveyor 80 can be controlled by the drive mechanism 60 of the drive roller 56 that the amount of cover crop seed delivered can be controlled.

While dispensing a desired quantity of the cover crop seed from the reservoir to a field it will be understood that movement of the agricultural machine 1 or vehicle to which the cover crop seed dispensing apparatus 6 (and so the seed dispenser 30) is mounted as it traverses a field will naturally cause the cover crop seed to be jogged along the conveyor 80 and so through the seed dispenser 30 such that the first and second further rollers 66, 68 may be considered optional.

Nevertheless, various problems arise when delivering the wrong amount of cover crop seed to the conveyor 80 in the region of the entry of the seed dispenser 30. Among the issues encountered is that the weight of the cover crop seed, in particular when the hopper 18 is full, hinders movement of the endless conveyor 80 and prevents ready flow of the cover crop seed into cavities 92 in the endless conveyor 80. Additionally, the drive mechanism 60 is set to run at set speeds which limits control when dispensing material in different applications, for example the drive mechanism 60 may run faster than may be desired when fitted to a corn harvesting header 3 with narrow row spacing, such as 15-inch rows, when a lower rate of cover crop seed supply may be desired. Further, different types of cover crop seed have different flow characteristics, such that some cover crop seed flows less well through the dispensing apparatus 6 than others. In one embodiment, a flow control insert 100 is used to control flow rate through the cover crop seed dispensing apparatus 6.

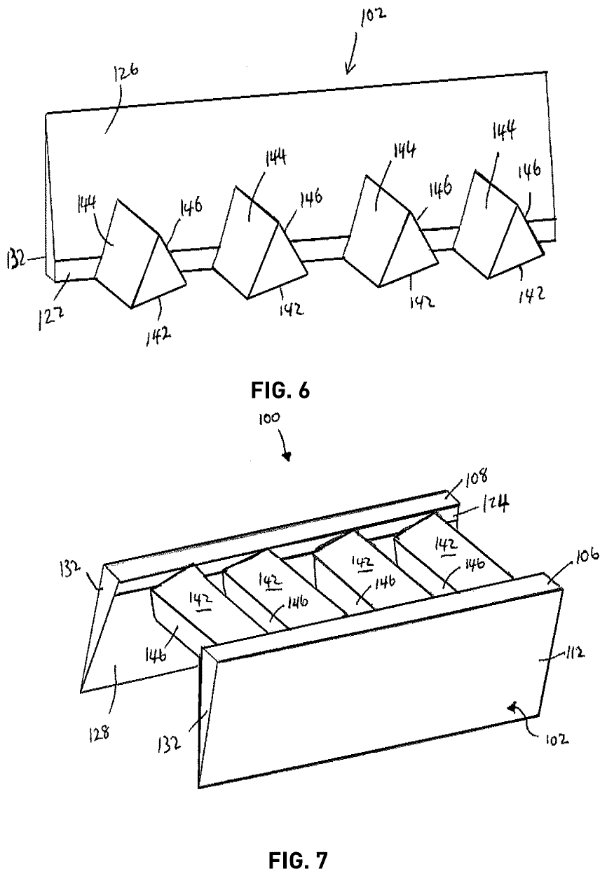

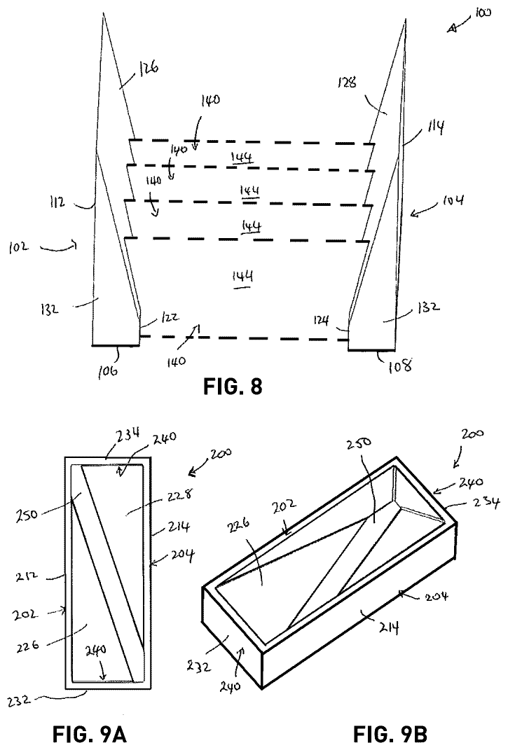

A first example flow control insert 100 is illustrated in FIGS. 5-8. The illustrated flow control insert 100 comprises first and second side walls 102, 104. The first and second side walls 102, 104 are arranged parallel to one another about a central longitudinal plane. It can be seen that in this example the first and second side walls 102, 104 mirror one another about this central plane. Each of the first and second side walls 102, 104 has a planar base 106, 108, in use adapted to be seated upon and ride on side edges of the conveyor 80. The bases 106, 108 of the first and second side walls 102, 104 each extend along a basal plane.

An outer surface 112, 114 of each of the first and second side walls 102, 104 is substantially vertical. An inner portion of each of the first and second side walls 102, 104 comprises a minor vertical surface 122, 124 and a major inclined surface 126, 128. The major inclined surface 126, 128 in each case extends from an upper edge of the respective side wall 102, 104 to an upper part of the minor vertical surface 122, 124. It can be seen that each of the side walls are of variable section between an upper edge of the side walls and a lower edge of the side walls.

Each end of the first and second side walls 102, 104 terminates in a substantially vertical surface 132, 134. The spacing of the vertical surfaces 112, 114, 132, 134 of each side wall 102, 104 allows the flow control insert 100, prior to the addition of particulate to the hopper, to be placed in the vertical opening forming the entry of the seed dispenser 30.

A plurality of connecting members 140 extend between the first and second side walls 102,104. In the first illustrated example four such connecting members 140 are shown. In this example, each connecting member 140 is triangular in section, having a lower base surface 142 and upper side surfaces 144, 146. As perhaps best seen in FIG. 7 these connecting members 140 are arranged at an angle to the basal plane, such that the lower base surface 142 of each connecting member 140 extends at each end from a first edge level with the basal plane defined by the lower edge of the minor vertical portion 122, 124 of the side wall 102, 104 to a second edge level with the upper edge of the minor vertical portion 122, 124 of the side wall 102, 104.

When placed in the vertical opening forming the entry of the seed dispenser 30, the side walls 102, 104, the connecting members 140 and the ends of the vertical opening (in the example dispenser, the guide plates 40, 42) define a plurality of openings 150 through which cover crop seed may flow from the hopper and into the cavities 92 formed in the conveyor 80. It can be seen that each of the openings 150 that are formed are of varying section between their upper and lower regions. In use, the inclined lower base surface 142 of this flow control insert 100 also serves to direct particulate material to fill the cavities 924 in the endless conveyor 80.

A second example flow control insert 200 is illustrated in FIGS. 9A and 9B. Like reference numerals increased by 100 from those used to refer to the first example flow control insert 100 will be used to illustrate the similarities of like parts.

The illustrated flow control insert 200 comprises first and second side walls 202, 204 located parallel to one on either side of a central longitudinal plane, though in this example the first and second side walls do not mirror one another about the central longitudinal plane. In this example the connecting members 240 between the first and second side walls form first and second end walls providing vertical surfaces 232, 234 at each end of the flow control insert 200.

An outer surface 212, 214 of each of the first and second side walls 202, 204 is substantially vertical. An inner portion of each of the first and second side walls 202, 204 comprises a vertical surface 222, 224 and an inclined surface 226, 228. In this example, each inclined surface 226, 228 is triangular and along a first side extends from an upper edge of the vertical surface adjacent an end wall to a lower edge of the vertical surface spaced from the opposite end wall. A second edge of each inclined surface 226, 228 extends from an upper edge of the adjacent end wall to a lower edge of the adjacent end wall spaced from the opposing side wall 202, 204. A third edge of each inclined surface extends along a basal plane of the flow control insert 200 connecting the first and second edges. An opening 250 is as a result defined between the opposing third edges of inclined surfaces 226, 228, the lower edges of the vertical surfaces 224, 226 not covered by the inclined surfaces 226, 228 and the lower edges of the connecting members 240 not covered by the inclined surfaces 226, 228.

It can be seen that each of the side walls are of variable section between an upper edge of the side walls and a lower edge of the side walls. Also, the opening 250 is of variable section between an upper region and a lower region, presenting a lowest cross-sectional area at the base of the flow control insert in the form of a diagonal slot extending across the flow control insert 200.

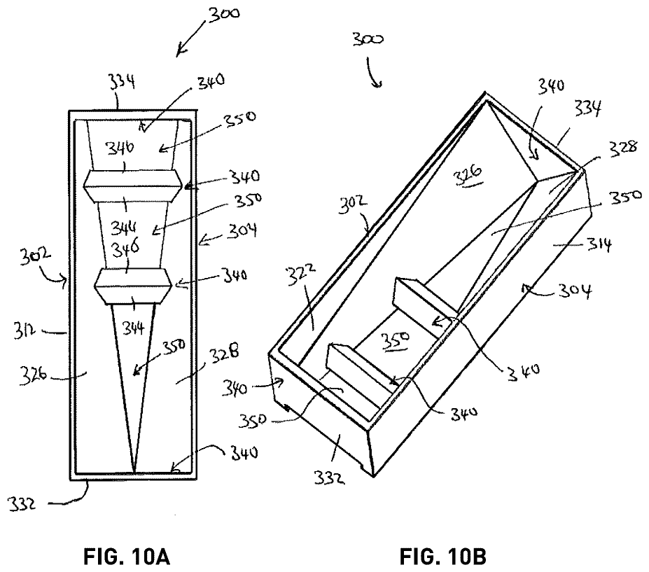

A third example flow control insert 300 is illustrated in FIGS. 10A and 10B. Like reference numerals increased by 200 from those used to refer to the first example flow control insert 100 will be used to illustrate the similarities of like parts.

The illustrated flow control insert 300 comprises first and second side walls 302,304 located parallel to one on either side of a central longitudinal plane. In this example the first and second side walls again mirror one another about a central longitudinal plane. In this example the connecting members 340 between the first and second side walls take the form of both first and second end walls providing vertical surfaces 332, 334 at each end of the flow control insert 300 and triangular elements connecting the side walls between the ends of the side walls 302, 304. In this example the connecting members 340 forming the first and second end walls extend from an upper edge of the respective side walls 302, 304 but are spaced from a lower edge of the respective side walls. As best seen in FIG. 10B the lower edges of each side wall 302, 304 are shaped to form longitudinally extending portions or skids 360 to support, in use, the flow control insert 300 on the edges of the conveyor 80.

An outer surface 312, 314 of each of the first and second side walls 302, 304 is substantially vertical. An inner portion of each of the first and second side walls 302, 304 comprises a vertical surface 322, 324 and an inclined surface 326,328. In this example, each vertical surface 322, 324 is triangular and along a first side extends along an upper edge of the side wall 302, 304. A second edge of each vertical surface 322, 324 extends from an upper edge at a first end of the flow control insert 300, part way down toward the basal plane of flow control insert 300. A third edge of each vertical surface 322, 324 connects the first and second edges. Each inclined surface 326, 328 extends from the third edge of the vertical surface 322, 324 inward toward the central longitudinal plane. At a second end of the flow control insert each inclined surface 326, 328 contacts the other at a lower edge. As each lower edge of each inclined surface 326, 328 extends toward the first end of the flow control insert 300 it moves further away from the other.

An opening 350 is as a result defined between the opposing third edges of inclined surfaces 326, 328, the lower edges of the vertical surfaces 324, 326 not covered by the inclined surfaces 326, 328 and the lower edges of the connecting members 340 not covered by the inclined surfaces 326, 328.

In this example, the triangular elements connecting the inclined surfaces 326, 328 of the side walls 302, 304 are two in number: a first being located around halfway between the ends of the flow control insert 300 and a second located around halfway between the first and the second end of the flow control insert 300.

It can be seen that each of the side walls are of variable section between an upper edge of the side walls and a lower edge of the side walls. Also, the opening 350 is of variable section between an upper region and a lower region, presenting a lowest cross-sectional area at the base of the flow control insert.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

All references cited herein are incorporated herein in their entireties. If there is a conflict between definitions herein and in an incorporated reference, the definition herein shall control. From reading the present disclosure, other modifications will be apparent to persons skilled in the art. Such modifications may involve other features which are already known in the field of apparatus for the processing of cut crop and component parts therefore and which may be used instead of or in addition to features already described herein.

What is claimed is:

1. An agricultural machine configured to harvest a crop by advancing a crop harvesting header across a field, the agricultural machine presenting a fore-and-aft extending longitudinal axis that extends in a direction of travel, the harvesting header having a header frame that mounts a cutting platform configured to sever crop being harvested, the header frame having a header axis that extends perpendicular to the direction of travel, wherein the agricultural machine has a cover crop seed dispensing apparatus comprising:
a distribution line mounted along the header frame, the distribution line having a plurality of distribution points at spaced intervals along the header axis; and
a seed dispenser configured to meter cover crop seed delivery to the distribution line so as to distribute cover crop seed from the plurality of distribution points as the harvesting header severs crop from the field.

2. The agricultural machine of claim 1 wherein the harvesting header is a corn head and the cutting platform has a plurality of corn head snoots spaced laterally along the header frame operable to be advanced along a series of side-by-side corn rows, wherein the distribution points are positioned between the corn rows as the agricultural machine travels across the field.

3. The agricultural machine of claim 1 wherein the harvesting header has a first cover crop seed dispensing apparatus on a first side of the harvesting header to supply the distribution points on the first side and a second cover crop seed dispensing apparatus 6 on a second side of the harvesting header to supply the distribution points on the second side.

4. The agricultural machine of claim 1 wherein the seed dispenser comprises an endless conveyor provided with a plurality of cavities, drive means to enable movement of the endless conveyor, an entry to the cover crop seed dispensing apparatus located above the endless conveyor and an exit from the seed dispenser located beneath the endless conveyor for transport of cover crop seed from the seed dispenser to the distribution line, wherein the seed dispenser further comprises a flow control insert located within the seed dispenser above the endless conveyor for controlling a flow of cover crop seed to the distribution line.

5. The agricultural machine of claim 4 wherein the flow control insert comprises:
first and second side walls, located parallel to one another either side of a central longitudinal plane, each side wall having provided with a planar base and an inner surface comprising a major surface inclined to the central longitudinal plane and a minor vertical surface;
a plurality of connecting members extending between the first and second side walls; and
one or more openings defined at least in part by the side walls and the connecting members.

6. The agricultural machine of claim 5 wherein each of the first and second side walls is provided with a planar base.

7. The agricultural machine of claim 5 wherein the plurality of connecting members are each of triangular section.

8. The agricultural machine of claim 5 wherein a lower surface of each of the plurality of connecting members is inclined to the planar base.

9. The agricultural machine of claim 5 wherein first and second of the plurality of connecting members connecting members connect first and second ends of the first and second side walls to form first and second end walls.

10. The agricultural machine of claim 5 wherein the flow control insert is of variable section between an upper edge of the side walls and a lower edge of the side walls.

11. The agricultural machine of claim 5 wherein each of the openings decreases in section from an upper region to a lower region.

12. The agricultural machine of claim 1 wherein the agricultural machine comprises a combine harvester.
